(19) United States
(12) Patent Application Publication
(10) Pub. No.: US 2009/0274505 A1
(43) Pub. Date: Nov. 5, 2009

(54) Braille Writer

(76) Inventors: David S. Morgan, Clinton, MA (US); David A. Carhart, Cary, IL (US); Stanislav Dmitriyev, Chervonograd (UA); Bjorn James Gunderson, Chicago, IL (US); Sona Patadia, Chicago, IL (US); Linda Pulik, Calgary (CA); Lisa A. Yanz, Chicago, IL (US)

Correspondence Address: CHOATE, HALL & STEWART LLP, TWO INTERNATIONAL PLACE, BOSTON, MA, 02110, US

(21) Appl. No.: 12/115,044

(22) Filed: May 5, 2008

(51) Int. Cl. B41J 3/32

(52) U.S. Cl. 400/109.1

(57) ABSTRACT

Mechanical braille writer. The braille writer includes a chassis supporting a plurality of finger operated keys with each key mechanically interconnected with an embossing mechanism so that depression of a key causes a corresponding one of a plurality of pins in the embossing mechanism to extend outwardly from the embossing mechanism to create a raised dot on paper adjacent to the embossing mechanism. The embossing mechanism comprises a block adapted for slidingly guiding the plurality of pins for paper contact. It is preferred that each one of the plurality of pins is straight and identical to the other pins.

### BACKGROUND OF THE INVENTION

This invention relates to a braille writer and more particularly to a mechanical braille writer with an improved embossing mechanism.

Braille was invented more than 175 years ago to provide a system that blind people can use to read and write. Braille is a system of raised dots that can be read very quickly with the fingers. Originally, Braille was written by hand using a slate and stylus to punch each of the dots in Braille letters one at a time. This process is rather slow.

More than 150 years ago, inventors started making machines to speed up the writing process. Most of the machines weren't very sturdy and some of them were quite expensive. In 1892 Frank Hall invented a braille writer that was different from the others in that it was similar to a typewriter but having six keys, one for each of the dots in a Braille cell.

During the first third of the twentieth century, the Perkins School for the Blind, the assignee of the present patent application, made braille writers that were very similar to Frank Hall's machine. In 1951 Perkins introduced a new braille writer shown in FIG. 1 that is considered by many to be the best braille writer ever developed. This braille writer remains in production to the present day.

There are quite a few other mechanical braille writers on the market. Some of these include Jot-A-Dot from Quantum Technologies; Erika Point from Brailletech; Tatrapoint from Brailletech; MK5 Braille Writer from DTW; Lavendar from American Printing House for the Blind; and Mountbatten from Quantum Technologies.

It is an object of the present invention to provide an updated and improved Perkins brailler that is lighter in weight, ergonomically improved and including an embossing mechanism that is simpler and less expensive to manufacture.

### SUMMARY OF THE INVENTION

In one aspect, the braille writer of the invention includes a chassis supporting a plurality of finger operated keys with each key mechanically interconnected with an embossing mechanism so that depression of a key causes a corresponding one of a plurality of pins in the embossing mechanism to extend outwardly from the embossing mechanism to create a raised dot on paper adjacent to the embossing mechanism. The embossing mechanism includes a block adapted for slidingly guiding the plurality of pins for paper contact. Each one of the plurality of pins is straight and substantially identical to the other pins.

In a preferred embodiment, as with current braille writers, there are six keys and six pins. The embodiment also includes an erase mechanism. In a preferred embodiment, margin guides are mounted at the front of the chassis and paper advance knobs are wingnut-shaped.

The braille writer of the invention is significantly lighter in weight than the previous Perkins braille writer. The present braille writer is more ergonomically refined and is less expensive to manufacture and assemble.

### BRIEF DESCRIPTION OF THE DRAWING

FIG. 1 is a perspective view of a prior art Perkins braille writer.

FIG. 2 is an exploded, perspective view of the prior art embossing mechanism used in the braille writer of FIG. 1.

FIG. 3 is a perspective view of the braille writer according to an embodiment of the invention.

FIG. 4 is a perspective, rear view of an embodiment of the invention disclosed herein.

FIG. 5 is an exploded, perspective view of the embossing mechanism according to an embodiment of the invention.

FIG. 6 is a perspective view, with cover removed, of an embodiment of the invention disclosed herein.

FIG. 7 is a plan view, with cover removed, of the embodiment of the invention shown in FIG. 6.

FIG. 8 is a bottom view of the embodiment of the invention shown in FIG. 7.

### DESCRIPTION OF THE PREFERRED EMBODIMENT

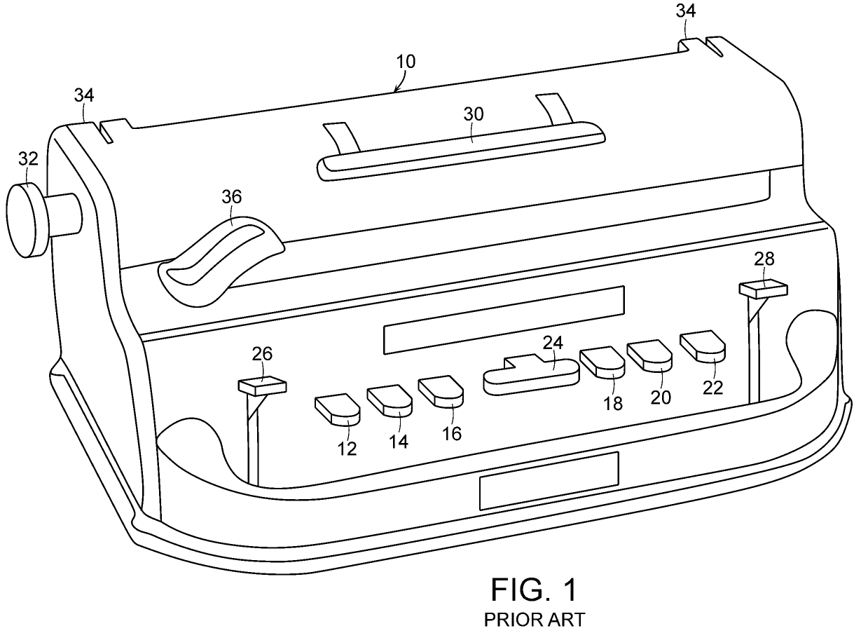

With reference first to FIG. 1, a prior art mechanical braille writer 10 includes six keys 12-22 each one of which controls an embossing pin for making raised dots on paper. A spacer bar 24 creates a space in a line of braille code. A line spacer 26 and a back spacer 28 are also provided along with a handle 30. Paper is controlled by a paper feed knob 32 and a paper release 34. Finally, a carriage return lever 36 is provided to return an embossing mechanism to the beginning of a line.

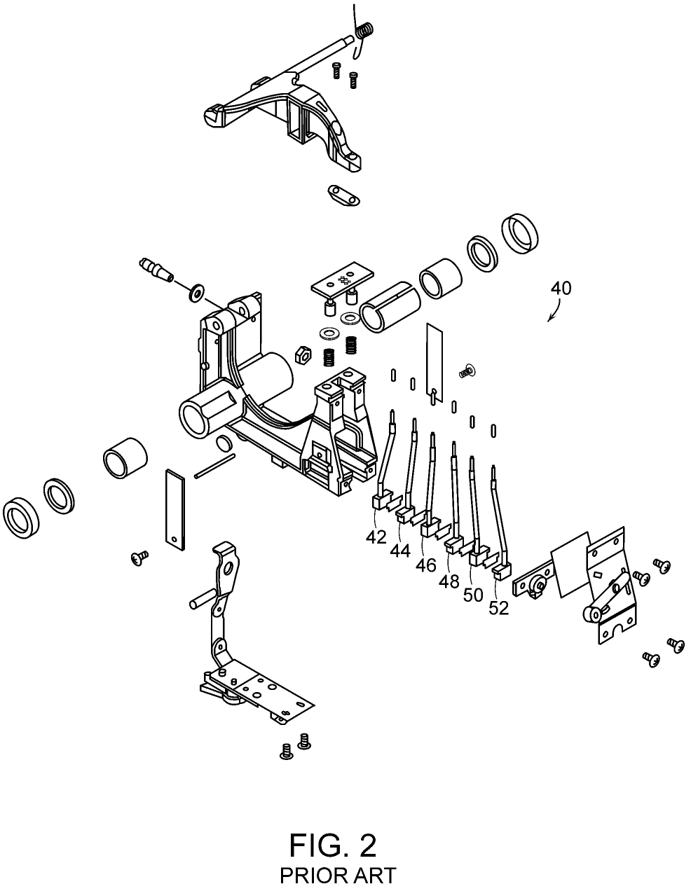

As those skilled in the art will appreciate, the mechanical braille writer 10 includes a movable embossing mechanism or carriage assembly that is shown in FIG. 2. This prior art embossing mechanism 40 includes six pins 42-52 each mounted in its own block. As can be seen in FIG. 2, the pins 42-52 are not straight and differ from one another. Because the pins 42-52 have different shapes, hand finishing is required for making the assembly. The pin design also requires careful adjustment and tuning during the assembly process. Those of ordinary skill in the art will appreciate that when one of the keys 12-22 is depressed, a corresponding one of the pins 42-52 will extend and create a raised dot in paper (not shown) in the braille writer 10.

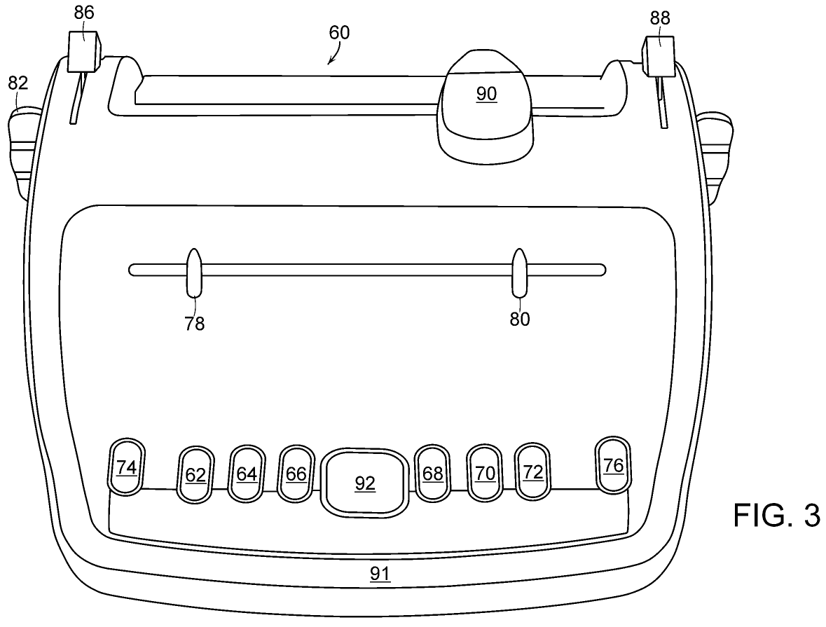

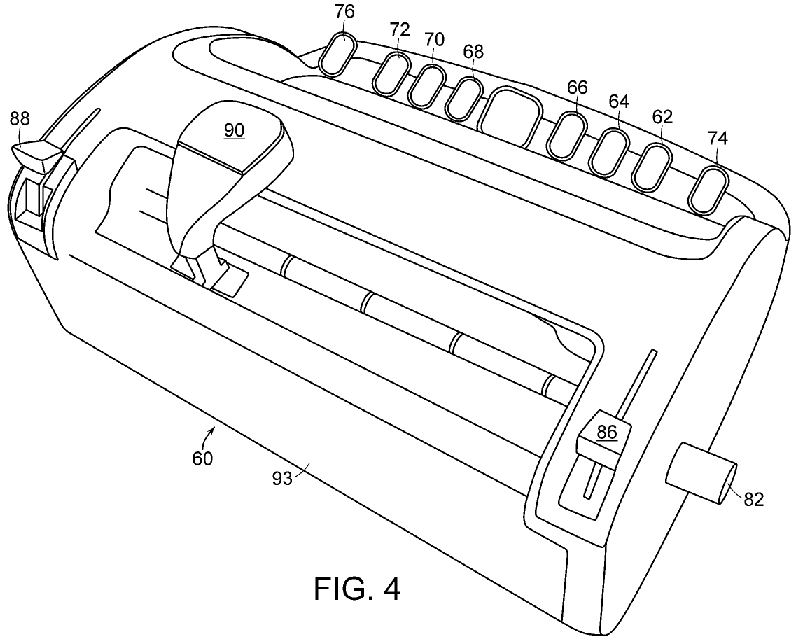

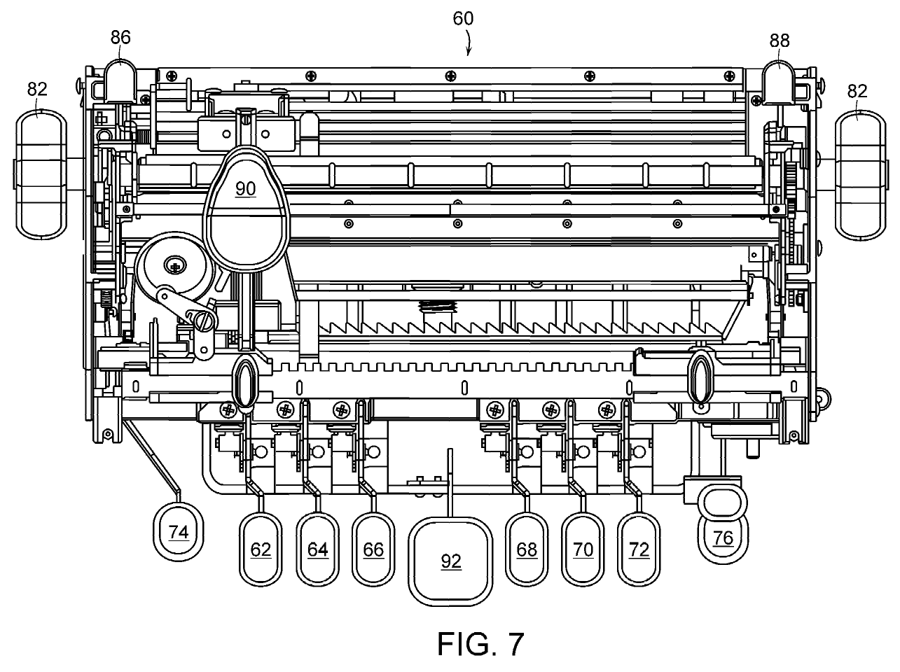

With reference now to FIGS. 3-5 an embodiment 60 of the new Perkins braille writer includes embossing keys 62-72, a line spacing key 74 and a back space key 76. Note that margin guides 78 and 80 are at the front of the braille writer 60 rather than in the back as is the case with the prior art braille writer shown in FIG. 1. This embodiment also includes paper advance knobs 82 and 84 that have a “wingnut” configuration for ease of gripping. This embodiment also includes paper release levers 86 and 88. This embodiment also includes an embossing mechanism or carriage assembly 90. A front portion 91 (FIG. 3) of the braille writer 60 serves as an integrated handle. With reference to FIG. 4, a moveable panel 93 serves an integrated paper tray, reading rest and alignment surface. FIG. 7 shows a paper drum assembly.

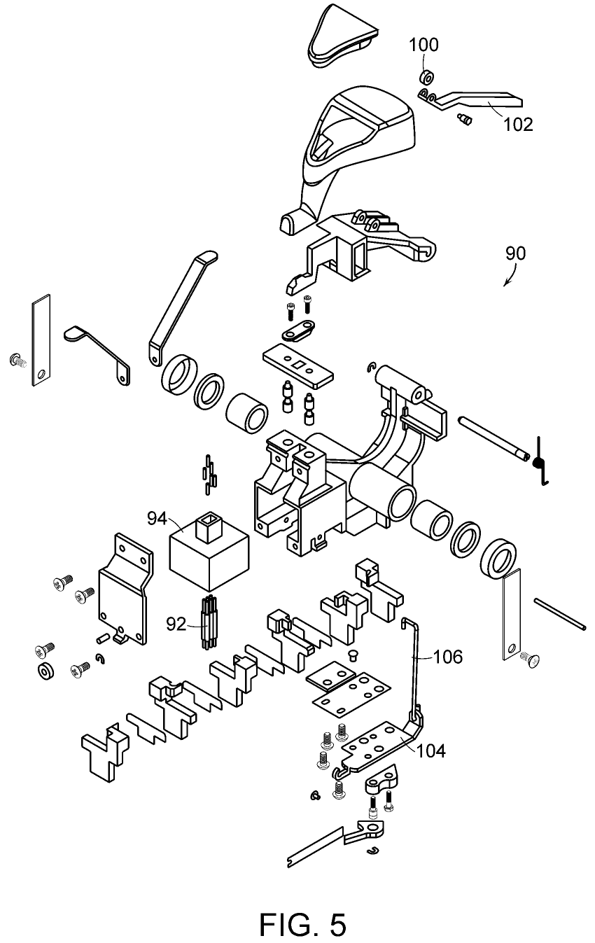

The embossing mechanism or carriage assembly 90 will now be described in more detail in conjunction with FIG. 5. The mechanism 90 includes an array of six pins 92 that are slidingly guided by structure 94. Note that the pins in the array of pins 92 are straight and identical to one another. In contrast to the prior art pins 42-52 shown in FIG. 2 that have differing, non-straight shapes, the straight pins 92 in the present embodiment are much easier to assemble and adjust.

With reference still to FIG. 5, the carriage head release mechanism will now be described. A button 100 may be pushed downwardly onto a beam 102. The beam 102 then lifts a cell spacer assembly 104 by means of a hooked wire 106. Thus, pushing the button 100 results in the lifting of the cell spacer assembly 104 away from the rack bar thereby releasing the carriage.

In operation, a user depresses one of the embossing keys 62-72 that causes a corresponding one of the pins in the array 92 to extend so as to emboss a raised dot on paper (not shown) passing between surfaces of the embossing mechanism 90. After a letter is created, the user activates a spacebar 92 to prepare for embossing a next letter.

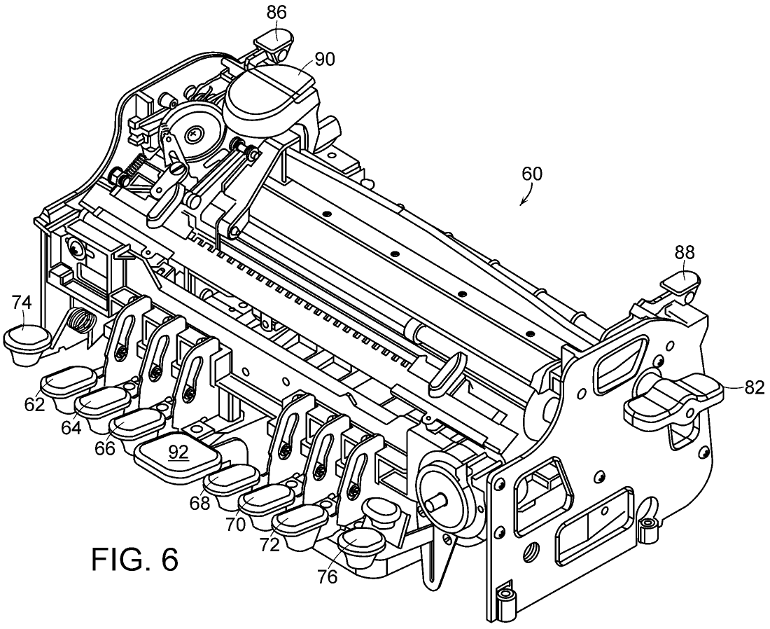

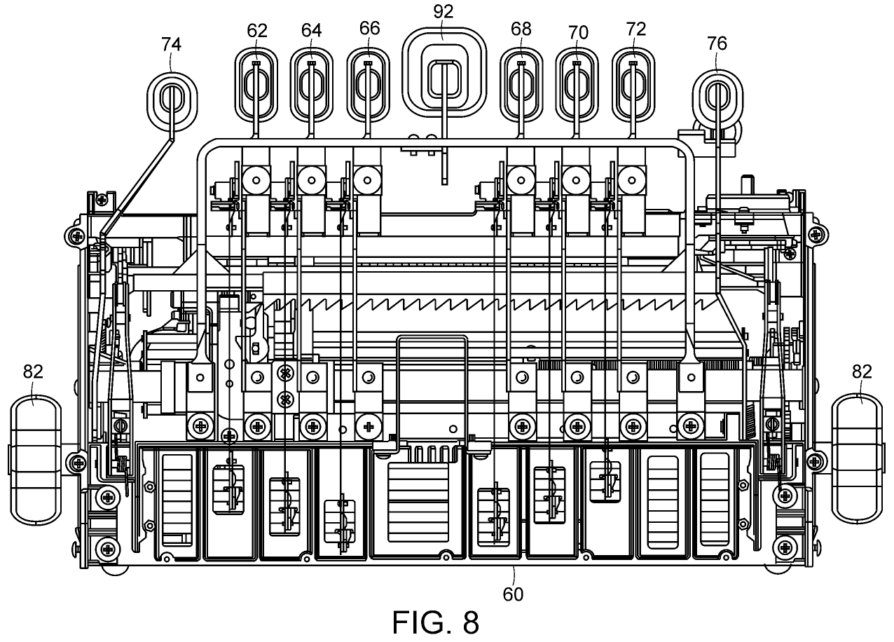

FIGS. 6, 7, and 8 are cutaways of the braille writer disclosed herein showing the mechanical interconnections that enable embossing.

The braille writer 60 disclosed herein is significantly lighter than its predecessor. The new braille writer 60 is also more ergonomically accommodating in that the margin guides 78 and 80 are on the front of the machine. It is also much easier and less expensive to assemble because of the unique carriage or embossing mechanism disclosed herein.

It is recognized that modifications and variations of the present invention will be apparent to those of ordinary skill in the art and it is intended that all such modifications and variations be included within the scope of the appended claims.

What is claimed is:

1. Braille writer comprising:
a chassis supporting a plurality of finger operated keys, each key mechanically interconnected with an embossing mechanism so that depression of a key causes a corresponding one of a plurality of pins in the embossing mechanism to extend outwardly from the embossing mechanism to create a raised dot on paper adjacent to the embossing mechanism;
wherein the embossing mechanism comprises a block adapted for slidingly guiding the plurality of pins for paper contact; and
wherein each one of the plurality of pins is straight and identical to the other pins.

2. The braille writer of claim 1 including six keys and six pins.

3. The braille writer of claim 1 further including an erase mechanism.

4. The braille writer of claim 1 further including margin guides mounted at the front of the chassis.

5. The braille writer of claim 1 further including a wingnut-shaped paper advance knob.

6. The braille writer of claim 1 further including a carriage head release and return mechanism.

7. The braille writer of claim 1 further including an integrated handle.

8. The braille writer of claim 1 further including an integrated paper tray, reading rest and alignment surface.

9. The braille writer of claim 1 further including a paper drum assembly.
